(19) United States
(12) Patent Application Publication
(10) Pub. No.: US 2009/0079947 A1
(43) Pub. Date: Mar. 26, 2009

(54) LIGHT SOURCE ASSEMBLY AND PROJECTOR HAVING SAME

(75) Inventors: MING-CHIH SUN, Tu-Cheng (TW); KAI HUANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/101,516

(22) Filed: Apr. 11, 2008

(30) Foreign Application Priority Data
Sep. 25, 2007 (CN) 200710201843.8

(51) Int. Cl. G03B 21/20; F21V 7/04

(52) U.S. Cl. 353/85; 362/310; 362/294

(57) ABSTRACT

A projector includes a lamp for providing a light beam, a reflective case for receiving and fixing the lamp, a cover, an image engine, and a projecting lens. The reflective case has an opening for allowing the light beam to be emitted therefrom. The cover includes a transparent portion covering the opening of the reflective case and a sidewall connected to the transparent portion. The sidewall is connected to the reflective case via screw threads. The image engine is positioned to receive light output from the lamp and configured for superimposing spatial information on the light to form image. The projecting lens is configured for receiving the light output of the image engine.

### RELATED FIELD

The present invention relates to a light source assembly, and, in particular, to a light source assembly having a simple configuration and a projector having same.

### BACKGROUND

Light sources are requisite in projectors to provide light beams. A light source includes a reflector and a cover connected to the reflector. Conventionally, the reflector is connected to the cover via additional methods, such as screws, or the like. However, the assembly of the light source is manually finished. Thus, mounting and tightening the screws to the cover on the reflector is time-consuming and inefficient. Therefore, manufacture cost and assembly time of the light source and the projector are increased.

It is desired to provide a light source assembly which can overcome the above-described deficiency.

### SUMMARY

In accordance with the present invention, a projector includes a lamp for providing a light beam, a reflective case for receiving and fixing the lamp, a cover, an image engine, and a projecting lens. The reflective case has an opening for allowing light from the lamp to be emitted therefrom. The cover includes a transparent portion covering the opening of the reflective case, and a sidewall connected to the transparent portion. The sidewall engages the reflective case via screw threads formed thereon. The image engine is positioned to receive light output from the lamp and configured for superimposing spatial information on the light to form images. The projecting lens is configured for receiving the light output by the image engine.

Other novel features and advantages will become more apparent from the following detailed description when taken in conjunction with the accompanying drawings.

### BRIEF DESCRIPTION OF THE DRAWINGS

The present invention is described in detail hereinafter, by way of example and description of preferred and exemplary embodiments thereof and with reference to the accompanying drawings, in which:

FIG. 1 is an isometric, exploded view of a light source assembly according to an exemplary embodiment; and

FIG. 2 is a cross-sectional view of a projector having the light source assembly of FIG. 1 according to the exemplary embodiment.

### DETAILED DESCRIPTION OF THE EXEMPLARY EMBODIMENTS

A detailed explanation of a light source assembly and a projector having the same according to an exemplary embodiment of the present invention will now be made with reference to the drawings attached hereto.

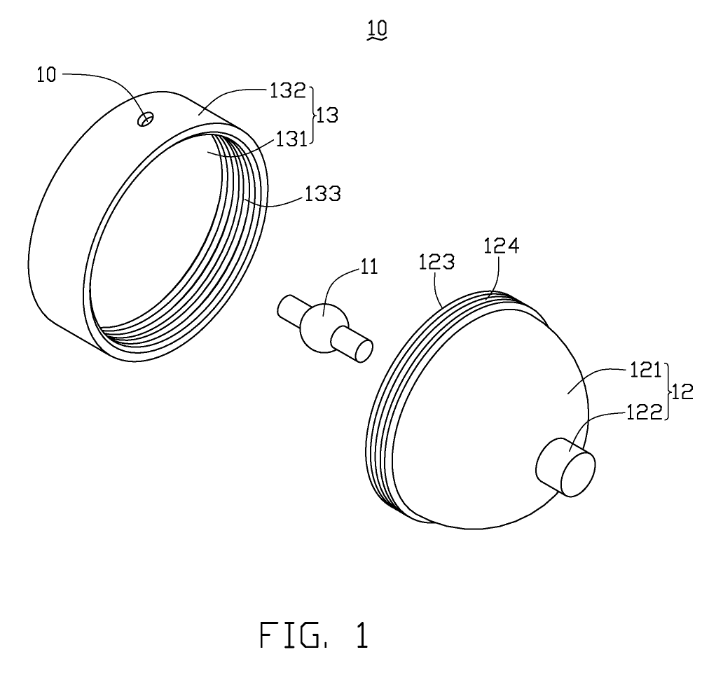

Referring to FIG. 1, a light source assembly 10 according to an exemplary embodiment of the present invention is shown. The light source assembly 10 includes a lamp 11, a reflective case 12 for receiving and fixing the lamp 11, and a cover 13 connected to the reflective case 12.

The lamp 11 is disposed in a space surrounded by the reflective case 12. The lamp 11 together with the reflective case 12 is configured for providing parallel light beams. The lamp 11 can be a halogen lamp, a metal halogen lamp, a light emitting diode (LED), and the like. In the exemplary embodiment, the lamp 11 is a halogen lamp that emits a white light.

The reflective case 12 may be an ellipsoidal reflector having two focal points and includes a reflector 121 and an assembling portion 122 connected to the reflector 121. The reflector 121 has an opening 123 for allowing the light beams from the lamp 11 to be emitted therefrom. It should be noted that reflective film (not shown) is employed on an inner surface of the reflector 121 to reflect the light beams emitted from the lamp 11. Understandably, the lamp 11 may be mounted in one of the two focal points for acquiring parallel light beams.

The cover 13 includes a transparent portion 131 covering the opening 123 of the reflective case 12 and a sidewall 132 connected to the transparent portion 131. It can be appreciated that the transparent portion 131 is integrally formed with the sidewall 132, and a surface of the sidewall 132 is coated black for preventing light leakage. The sidewall 132 defines an inner screw thread 133 therein, and the opening 123 of the reflective case 12 defines an outer screw thread 124 thereon for engaging with the inner screw thread 133 of the sidewall 132 to thereby connect the cover 13 to the reflective case 12. Alternatively, the inner screw thread 133 can be defined in the inner wall of the opening 124 of the reflective case 12, and correspondingly the outer screw thread 124 can be defined on the outer wall of the sidewall 132 for engaging with the inner screw thread 133 of the opening 123. The sidewall 132 defines at least an air outlet 134 therethrough for dissipating heat generated by the lamp 11. In the exemplary embodiment, the sidewall 132 has two air outlets 134.

As described above, the reflective case 12 is connected to the cover 13 via the screw threads in the light source assembly 10. Therefore, the light source assembly 10 has a simpler configuration than that of the conventional light source. And the manufacture cost of the light source assembly 10 can be decreased.

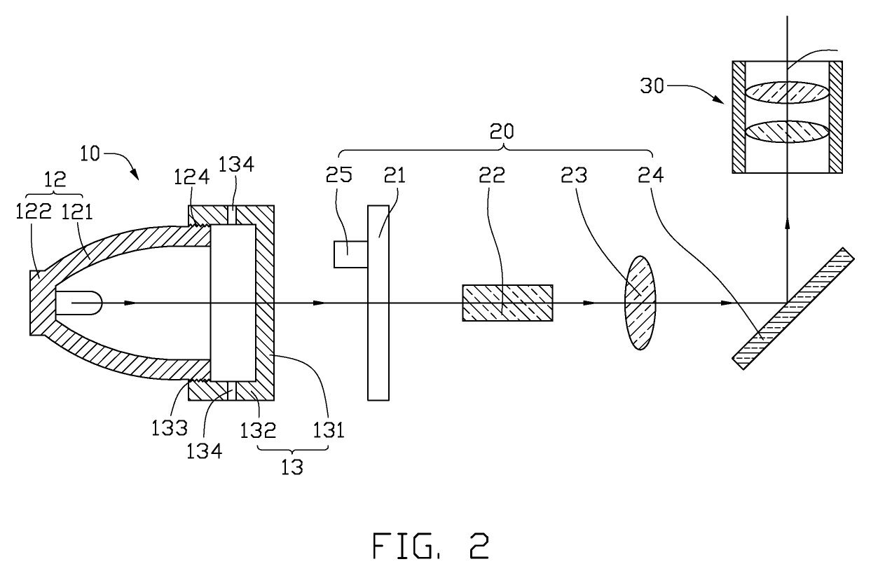

Referring to FIG. 2, a projector using the light source assembly 10 is shown. The projector is a digital light processing (DLP) projector in the exemplary embodiment. It should be noted that the light source assembly 10 could also be used in other kinds of projectors, for example a liquid crystal display (LCD) projector or a liquid crystal on silicon (LCOS) projector. In the present embodiment, the DLP projector is presented only as an example to explain working principles of the light source assembly 10. The projector includes the light source assembly 10, an image engine 20 positioned to receive the light output from the light source assembly 10, and a projecting lens 30 positioned to receive the light output from the image engine 30.

The image engine 20 includes a color wheel 21, a integrator 22, a condenser 23, and a digital micro-mirror device (DMD) 24. The color wheel 21 is configured for splitting the emergent light from the light source assembly 10 into time-sequenced red, green, and blue light beams. The color wheel 21 includes red, green, and blue color filters, and the center of the color wheel 21 is connected to a motor 25 such that the color wheel 21 can be rotated. The integrator 22 is configured for processing the light beam emitted from the color wheel 21 such that light beams exiting the integrator 22 have a uniform spatial distribution. The condenser 23 is a condensing lens and configured for avoiding dissipation of the light. The DMD 24 is positioned to receive the light output from the light source assembly 10 and configured for superimposing spatial information on the light and emits a light having image information.

The projecting lens 30 is configured for receiving the light output of the DMD 24, and magnifying the light output and projecting an image on a screen (not shown).

As described above, the cover can be directly assembled to the reflecting case 12 and firmly fixed therein utilizing the screw thread. Therefore, the time spent to assemble the light source is less than the conventional method.

It should be understood that the above-described embodiment are intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. A light source for a projector, comprising:
a lamp for providing a light beam for the projector;
a reflective case for receiving and fixing the lamp, the reflective case having an opening for allowing the light beam to be emitted therefrom; and
a cover for sealing the opening of the reflective case, the cover having a transparent portion therethrough for the passage of the light beam and a sidewall connected to the transparent portion, the sidewall being connected to the reflective case via screw threads.

2. The light source as claimed in claim 1, wherein the opening defines an inner screw thread thereon, and the sidewall of the cover defines an outer screw thread thereon configured for engaging with the inner screw thread of the opening.

3. The light source as claimed in claim 1, wherein the opening defines an outer screw thread thereon, and the sidewall of the cover defines an inner screw thread thereon configured for engaging with the outer screw thread of the opening.

4. The light source as claimed in claim 1, wherein the reflective case is an ellipsoidal reflector, and the lamp is mounted at one of two focuses of the reflective case.

5. The light source as claimed in claim 1, wherein the sidewall of the cover comprises at least an air outlet therethrough for dissipating heat generated by the lamp.

6. A projector, comprising:
a lamp for providing light beams;
a reflective case for receiving and fixing the lamp, the reflective case having an opening therethrough for passage of the light beams;
a cover for sealing the opening of the reflective case, the cover having a transparent portion therethrough for the passage of the light beam passing and a sidewall connected to the transparent portion, the sidewall being connected to the reflective case via screw threads;
an image engine positioned to receive light output from the lamp and configured for superimposing spatial information on the light to form image; and
a projecting lens configured for receiving the light output of the image engine.

7. The projector as claimed in claim 6, wherein the opening defines an inner screw thread thereon, and the sidewall of the cover defines an outer screw thread thereon configured for engaging with the inner screw thread of the opening.

8. The projector as claimed in claim 6, wherein the opening defines an outer screw thread thereon, and the sidewall of the cover defines an inner screw thread thereon configured for engaging with the outer screw thread of the opening.

9. The projector as claimed in claim 6, wherein the reflective case is an ellipsoidal reflector, and the lamp is mounted at one of two focuses of the reflective case.

10. The projector as claimed in claim 6, wherein the sidewall of the cover comprises at least an air outlet therethrough for dissipating heat generated by the lamp.
